(19) United States
(12) Patent Application Publication
(10) Pub. No.: US 2008/0074390 A1
(43) Pub. Date: Mar. 27, 2008

(54) Cordless communication device with laser beam and mouse ball

(76) Inventors: Li-Hung Lai, Hsinchu City (TW); Kun-Fang Huang, Hsinchu City (TW); Wen-Sheng Hsieh, Hsinchu City (TW); Wu-Chung Chiang, Hsinchu City (TW); Chih-Feng Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/527,482

(22) Filed: Sep. 27, 2006

(51) Int. Cl. G09G 5/08

(52) U.S. Cl. 345/163

(57) ABSTRACT

A communication device is provided with a ball turned by hand to reflect a laser beam within a housing. The laser beam proceeding within the housing is in response to motion of the ball and received by a light sensor. The communication device is capable of operation without providing a panel for the ball.

### BACKGROUND OF THE INVENTION

1. Field of the Invention

The present invention relates to cordless communication device with laser beam, and more especially, to the cordless mouse with laser beam in cooperation with mouse ball.

2. Description of the Related Art

A conventional mouse in communication with a computer is moved on a panel with a mouse ball. One of drawbacks for such a conventional mouse is that the mouse ball becomes not sensitive to the motion, once rolling bars for the mouse ball are frequently dirty. Thus, optic mouse replaces mechanical mouse with mouse ball. The optic mouse utilizes a light source, such as a light emitting diode, to send a visible light incident onto a panel on which the optic mouse moves. However, the light emitting diode consumes much power, thus batteries equipped are frequently renewed, which causes operator inconveniently using the optic mouse. Furthermore, the light generated by the light emitting diode is sensitive to the contrast of the panel. Thus, the power of the light is frequently adjusted for sensing the motion of the optic mouse. Accordingly, a power adjustment is necessary for the light source of the optic mouse.

### SUMMARY OF THE INVENTION

In order to solve above issues, one of objects of the present invention provides a communication device equipped with laser beam as sensed light. The laser beam is less sensitive to an incident surface than a light emitting diode, such that power adjustment is not necessary for the usage of laser beam.

Another one of objects of the present invention is to provide a computer communication device equipped with a ball and laser beam. The laser beam is directly incident onto the surface of the ball within a housing and consumes less power than a conventional optic mouse.

Accordingly, one embodiment of the present invention is to provide communication device. A signal generator is freely turning mounted on a housing and configured to provide a turning surface within the housing. A light beam generator is configured to transmit a laser light beam incident onto the turning surface within the housing and send a signal in response to motion of the signal generator. A signal receiver is mounted within the housing and configured to receive and process the signal. A signal emitter is configured to send a controlling signal in response to the processed signal.

### BRIEF DESCRIPTION OF THE DRAWINGS

FIG. 1 is a top view of a communication device constructed as a mouse in accordance with a preferred embodiment of the present invention;

FIG. 2 is a schematic cross-sectional view diagram illustrating the interior of the wireless mouse 10 in accordance with one embodiment of the present invention; and

FIG. 3 is a block diagram illustrating the exemplary communication device in accordance with one embodiment of the present invention.

### DETAILED DESCRIPTION OF THE INVENTION

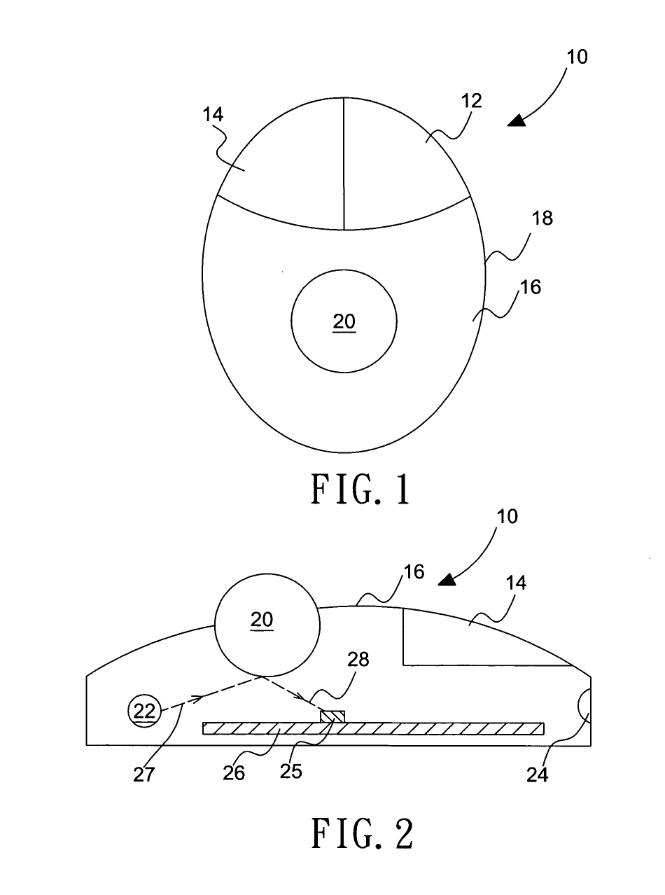

With reference to FIGS. 1-3, where like numerals designate like elements, there are illustrated a wireless mouse capable of tracking and transmitting operational and motion signals through a beam of laser light incident on a mouse ball. FIG. 1 is a top view of a communication device constructed as a mouse in accordance with a preferred embodiment of the present invention. Shown in FIG. 1, a wireless mouse 10 has conventional buttons 12 and 14 on a first surface 16 of a housing, such as an upper surface. The wireless mouse 10 also has a mouse ball 20 on the first surface 16 or a second surface 18, such as one of sides or an undersurface. The buttons 12 and 14 are separately operable, and each button 12, 14 sends a specific wireless signal, such as infrared (IR), to a computer or other like device through a port (not shown in FIG. 1) located on a front surface. In one embodiment, the mouse ball 20 is in one opening located on the first surface 16 or the second surface 18 and capable of turning freely in the opening. Furthermore, the mouse ball 20 may be turned directly by an operator's finger instead of moved on an exterior panel, such as pad on a panel. Thus, when construed as a cursor displayed on a screen of a computer or other like device in communication, the wireless mouse 10 may indicate the cursor with turning the mouse ball 20 by the finger, rather than touching the mouse ball 20 on the exterior panel.

FIG. 2 is a schematic cross-sectional view diagram illustrating the interior of the wireless mouse 10 in accordance with one embodiment of the present invention. In the embodiment, a portion of the mouse ball 20 is sunk beneath the first surface 16 of the housing and other portion is protruded above the first surface 16. A light source 22 and a printed circuit board 26 are mounted on an inner surface of the housing. When the mouse ball 20 is turned by single operator's finger, a laser beam 27 generated by the light source 22 is incident onto the surface of the mouse ball 20 and reflected laser beam 28 is received by a capturing device 25, such as a CMOS sensor. It is understood that the capturing device 25 is cooperated with other devices (not shown) on the printed circuit board 26 to process the signals of the reflected laser beam 28. Of course, the printed circuit board 26 also processes the operational signals in response to the button 12 or 14. Furthermore, the printed circuit board 26 sends infrared signals in response to the buttons 12, 14 or the movement of the mouse ball 20 through a port 24 on the front surface to control a computer or other like device. In the embodiment, the signals transmitted by a wireless mouse 10 to a computer may not be sent without a physical transmission line. Alternatively, the signals from the printed circuit board 26 may be transmitted as radio frequency signals.

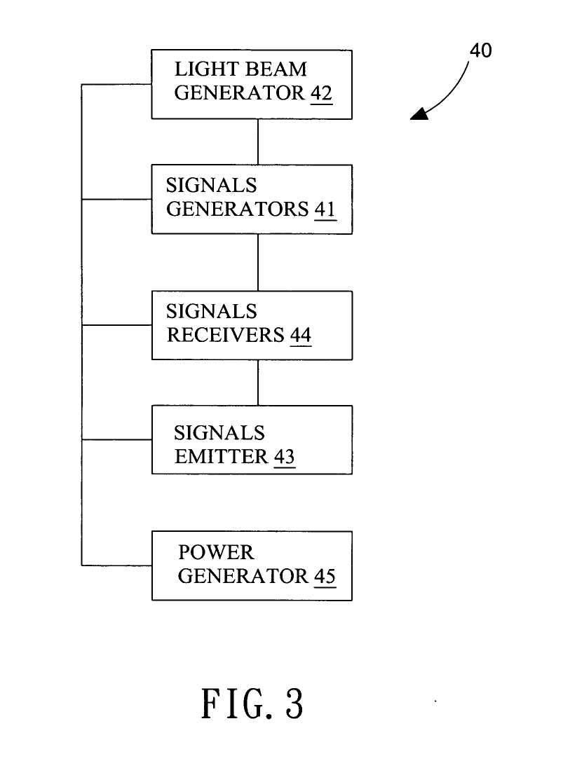

Accordingly aforementioned, FIG. 3 is a block diagram illustrating the exemplary communication device in accordance with one embodiment of the present invention. The communication device 40 includes a light beam generator 42, signals generators 41, signals receivers 44, signals emitter 43 and power generator 45. In one embodiment, the communication device 40 may be a cordless mouse, a trackball apparatus or other like device. The light beam generator 42 may generate light beam, such as laser beam or any other focused or narrow beam of light incident onto one of signals generators 41, such as the surface of a mouse ball of the signals generators 41. Preferably, laser beam is selected because it is not sensitive to the surface property of the mouse ball of the signals generators 41. Furthermore, the light beam generated by the light beam generator 42 proceeds only within the communication device 40 to ensure doing people no harm.

In addition to the mouse ball, the signals generators 41 further include the operating buttons, such as the buttons 12 and 14 in FIG. 1. One of functions of the signals generators 41 is to generate information or controlling signals when they are moved or switched. In the embodiment, the mouse ball reflects the light beam from the light beam generator 42 in response to its movement. The buttons send controlling signals in response to their pressing or depressing. Next, the signals receivers 44 receive the signals sent by the signals generators 41. In the embodiment, the signals receivers 44 include a light sensor, such as a CMOS or CCD sensor, to receive the reflected light beam from the mouse ball. It is understood that the signals receivers 44 further include a circuit to receive the controlling signals from the operating buttons. Alternatively, the CMOS sensor and the circuit may be integrated into the printed circuit board. The signals emitter 43 communicates the signals receivers 44 to send the processed signals from the signals receivers 44. In the embodiment, the signals indicating the movement of the mouse ball are transmitted through the signals emitter 43 to control the communicated computer or other like device. Furthermore, the signals indicating the pressing and depressing of the operating buttons are also transmitted through the signals emitter 43 to control the communicated computer or other like device. It is understood that the signals emitter 43 may be integrated into the printed circuit board. The power generator 45 provides necessary power for the light beam generator 42, signals receivers 44 and the signals emitter 43. In the embodiment, the power generator 45 is one or set of batteries housed within the communication device 40.

Although the present invention has been explained in relation to its preferred embodiment, it is to be understood that other modifications and variation can be made without departing the spirit and scope of the invention as hereafter claimed.

What is claimed is:

1. A communication device, comprising:
a first signal generator freely turning mounted on a housing and configured to provide a turning surface within said housing;
a light beam generator configured to transmit a laser light beam incident onto said turning surface within said housing and send a first signal in response to motion of said first signal generator;
a first signal receiver mounted within said housing and configured to receive and process said first signal; and
a signal emitter configured to send a controlling signal in response to said processed first signal.

2. The communication device according to claim 1, wherein said first signal generator includes a mouse ball.

3. The communication device according to claim 1, wherein said first signal receiver includes a complementary metal-oxide-semiconductor sensor.

4. The communication device according to claim 1, wherein said first signal receiver includes a charge-coupled device.

5. The communication device according to claim 1, wherein said first signal receiver comprises a printed circuit board.

6. The communication device according to claim 1, wherein said first controlling signal comprises an infrared ray signal.

7. The communication device according to claim 1, comprising a cordless mouse.

8. The communication device according to claim 1, further comprising a second signal generator configured to send a second signal in response to operation of said second signal generator.

9. The communication device according to claim 8, wherein said second signal generator includes at least one button mounted on said housing.

10. The communication device according to claim 8, further comprising a second signal receiver configured to receive said second signal.

11. The communication device according to claim 10, wherein said second signal receiver comprises a printed circuit board.

12. The communication device according to claim 1, further comprising a power generator configured to provide power for said laser beam generator, said first signal receiver and said signal emitter.

13. The communication device according to claim 1, wherein said laser beam proceeds within said housing.

14. A computer mouse, comprising:
a mouse ball freely turning mounted on a housing and providing a reflective surface within said housing;
a laser beam generator mounted within said housing and configured to send a laser beam onto said reflective surface to generate a reflected light beam proceeding within said housing;
a light sensor configured to receive said reflected light beam in response to motion of said mouse ball;
a processing circuit cooperated with said light sensor and configured to process said reflected light beam from said light sensor; and
a light emitter configured to send a controlling signal to a computer.

15. The computer mouse according to claim 14, further comprising a power generator configured to provide power for said laser beam generator, said light sensor and said processing circuit.

16. The computer mouse according to claim 14, wherein said light emitter comprises a printed circuit board and a port mounted on an inner surface of said housing.

17. The computer mouse according to claim 14, wherein said controlling signal is an infrared ray signal.

18. The computer mouse according to claim 14, wherein said light sensor comprises a complementary metal-oxide-semiconductor sensor.

19. The computer mouse according to claim 14, wherein said laser beam proceeds within said housing.
